(19) United States
(12) Patent Application Publication
(10) Pub. No.: US 2006/0156333 A1
(43) Pub. Date: Jul. 13, 2006

(54) Distance check for television signal receiver having an emergency alert function

(75) Inventor: Scott Allan Kendall, Westfield, IN (US)

Correspondence Address: THOMSON LICENSING INC., PATENT OPERATIONS, PO BOX 5312, PRINCETON, NJ, 08543-5312, US

(73) Assignee: THOMASO LICENSING S.A., WESTFIELD (US)

(21) Appl. No.: 10/519,043

(22) PCT Filed: Jun. 26, 2003
(86) PCT No.: PCT/US03/19941

§ 371 Date: Dec. 22, 2004

Related U.S. Application Data
(60) Provisional application No. 60/391,912, filed on Jun. 27, 2002.

(51) Int. Cl. H04N 7/025; H04N 5/445; H04N 7/08; H04N 9/64; H04N 7/10; H04N 7/084

(52) U.S. Cl. 725/33; 348/33; 348/563; 348/473

(57) ABSTRACT

A television signal receiver having an emergency alert function is capable of checking a distance between a reference point and a point associated with a geographical area selected by a user during a setup process for the emergency alert function. According to an exemplary embodiment, the television signal receiver includes a memory Operative to store data associated with the emergency alert function. A processor is operative to receive an input representing a geographical area, and to enable a predetermined output responsive to the input using the data in the memory when a distance between a reference point and a point associated with the geographical area exceeds a predetermined distance.

The present invention generally relates to television signal receivers, and more particularly, to television signal receivers having an emergency alert function capable of, among other things, checking a distance between a reference point and a point associated with a geographical area selected by a user during a setup process for the emergency alert function, and providing a predetermined output when the distance exceeds a predetermined distance.

Emergency events such as severe weather, natural disasters, fires, civil emergencies, war acts, toxic chemical spills, radiation leaks, or other such conditions can be devastating to unprepared individuals. With weather-related emergencies, authorities such as the National Weather Service (NWS) and the National Oceanographic and Atmospheric Administration (NOAA) are generally able to detect severe weather conditions prior to the general public. Through the use of modern weather detection devices, such as Doppler radar and weather satellites, the NWS and NOAA are able to issue early warnings of severe weather conditions which have saved many lives. However, for such warnings to be effective, they must be communicated to their intended recipients.

Certain specialized radios and frequency scanners are capable of receiving emergency alert signals provided by the NWS and NOAA. However, such devices tend to be dedicated to this use, and generally offer consumers little, if any, functionality beyond monitoring these signals. Accordingly, in order to receive advance warning of weather-related emergencies, consumers are required to purchase a separate, dedicated device, which may be cost-prohibitive to some consumers.

Certain such devices provide an emergency alert function using Specific Area Message Encoding (SAME) technology. Devices using SAME technology typically require a user to perform a setup process for the emergency alert function by selecting items such as one or more geographical areas of interest, and one or more types of emergency events which activate the emergency alert function. Once the setup process is complete, the emergency alert function may be activated when incoming emergency alert signals including SAME data indicate the occurrence of an emergency event which corresponds to the geographical area(s) and event type(s) selected by the user during the setup process. When the emergency alert function is activated, an alert output such as an audio message may be provided to alert individuals of the emergency event.

One problem associated with devices using technology such as SAME technology involves the aforementioned setup process for the emergency alert function. As previously indicated, the setup process typically requires a user to select one or more geographical areas of interest. During the setup process, some users may select geographical areas which are relatively far away from one another. For example, a user may select Indianapolis, Ind. as one geographical area, and select Princeton, N.J. as another geographical area, with the desire of being notified of emergency events in both areas. In reality, however, emergency alert signals are generally broadcast from specific locations and the transmission range of such broadcasts may be limited, such as between 50 and 200 miles. Moreover, transmission sources usually only broadcast emergency alert signals for their corresponding reception area. Accordingly, a user in Indianapolis, Ind. will most likely never receive notification of an emergency event in Princeton, N.J., even though both geographical areas may have been selected during the setup process. In this manner, the setup process for the emergency alert function may give users a false impression of being able to receive notifications of emergency events for geographical areas which are relatively far away from one another.

Accordingly, there is a need for a device having an emergency alert function which avoids the foregoing problems. The present invention addresses these and other issues.

In accordance with an aspect of the present invention, a method for controlling a television signal receiver having an emergency alert function with an associated setup process is disclosed. According to an exemplary embodiment, the setup process comprises steps of receiving an input representing a geographical area, and providing a predetermined output when a distance between a reference point and a predetermined point associated with the geographical area exceeds a predetermined distance.

In accordance with another aspect of the present invention, a television signal receiver having an emergency alert function is disclosed. According to an exemplary embodiment, the television signal receiver comprises memory means for storing data associated with the emergency alert function. Processing means receive an input representing a geographical area, and enable a predetermined output responsive to the input using the data in the memory means when a distance between a reference point and a point associated with the geographical area exceeds a predetermined distance.

The above-mentioned and other features and advantages of this invention, and the manner of attaining them, will become more apparent and the invention will be better understood by reference to the following description of embodiments of the invention taken in conjunction with the accompanying drawings, wherein:

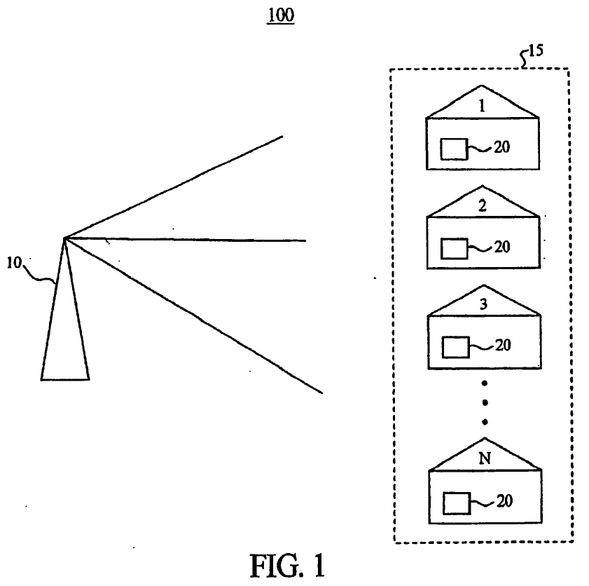

FIG. 1 is an exemplary environment suitable for implementing the present invention;

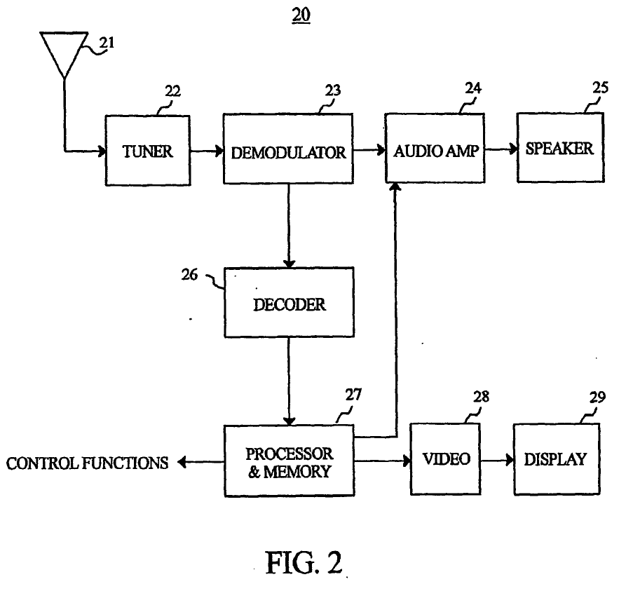

FIG. 2 is a block diagram of a television signal receiver according to an exemplary embodiment of the present invention;

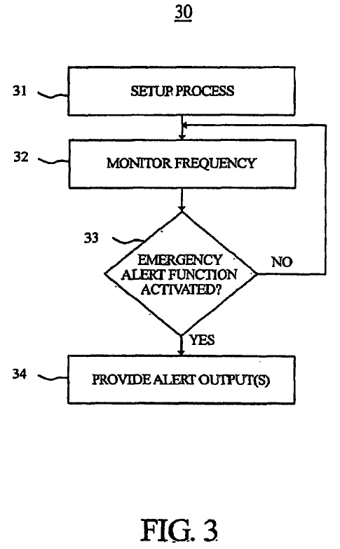

FIG. 3 is a flowchart illustrating exemplary steps according to the present invention;

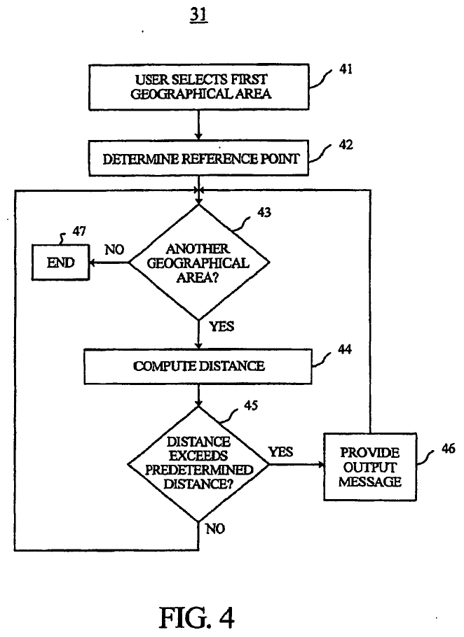

FIG. 4 is a flowchart illustrating further exemplary details of one of the steps of FIG. 3;

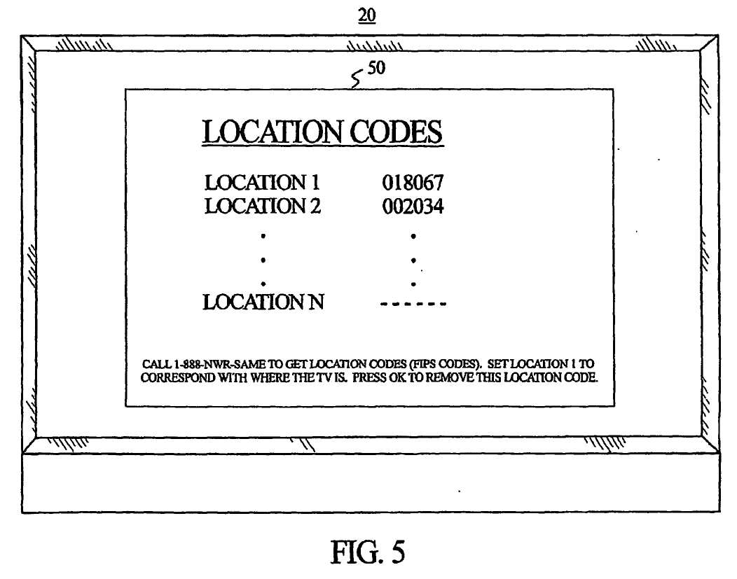

FIG. 5 is another diagram of a television signal receiver providing a user interface according to an exemplary embodiment of the present invention; and

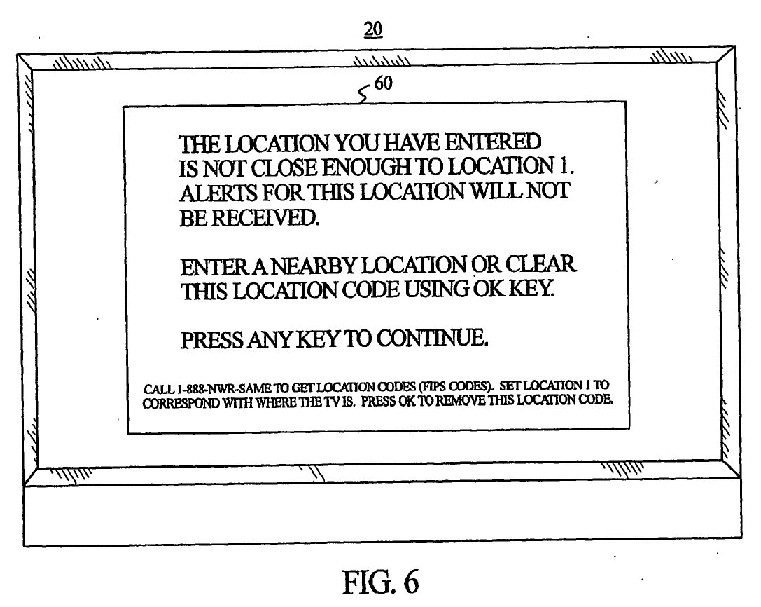

FIG. 6 is another diagram of a television signal receiver providing an output message according to an exemplary embodiment of the present invention.

The exemplifications set out herein illustrate preferred embodiments of the invention, and such exemplifications are not to be construed as limiting the scope of the invention in any manner.

Referring now to the drawings, and more particularly to FIG. 1, an exemplary environment 100 suitable for implementing the present invention is shown. In FIG. 1, environment 100 comprises signal transmission means such as signal transmission source 10, dwelling means such as dwelling units 15 (i.e., 1, 2, 3 . . . N, where N may be any positive integer), and signal receiving means such as television signal receivers 20.

In FIG. 1, dwelling units 15 may represent residences, businesses and/or other dwelling places located within a particular geographical area, such as but not limited to, a particular continent, country, region, state, area code, zip code, city, county, municipality, subdivision, and/or other definable geographical area. According to an exemplary embodiment, each of the dwelling units 15 is equipped with at least one television signal receiver 20 having an emergency alert function. According to the present invention, the emergency alert function enables television signal receiver 20 to receive emergency alert signals and provide one or more alert outputs to notify individuals of an emergency event. As will be discussed later herein, television signal receiver 20 is capable of checking a distance between a reference point and a point associated with a geographical area selected by a user during a setup process for the emergency alert function, and providing a predetermined output when the distance exceeds a predetermined distance.

According to an exemplary embodiment, signal transmission source 10 transmits signals including emergency alert signals which may be received by each television signal receiver 20. The emergency alert signals may be provided from an authority such as the NWS, or other authorities such as governmental entities or the like. In response to the emergency alert signals, each television signal receiver 20 may provide one or more alert outputs to thereby notify individuals of the emergency event. Signal transmission source 10 may transmit such emergency alert signals to television signal receivers 20 via any wired or wireless link such as, but not limited to, terrestrial, cable, satellite, fiber optic, digital subscriber line (DSL), and/or any other type of broadcast and/or multicast means.

Referring to FIG. 2, a block diagram of an exemplary embodiment of television signal receiver 20 of FIG. 1 is shown. In FIG. 2, television signal receiver 20 comprises signal receiving means such as signal receiving element 21, tuning means such as tuner 22, demodulation means such as demodulator 23, audio amplification means such as audio amplifier 24, audio output means such as speaker 25, decoding means such as decoder 26, processing means and memory means such as processor and memory 27, video processing means such as video processor 28, and visual output means such as display 29. Some of the foregoing elements may for example be embodied using integrated circuits (ICs). For clarity of description, certain conventional elements of television signal receiver 20 including control signals may not be shown in FIG. 2.

Signal receiving element 21 is operative to receive signals including audio and/or video signals from signal sources, such as signal transmission source 10 in FIG. 1. According to an exemplary embodiment, received audio signals may include digitally encoded emergency alert signals. Signal receiving element 21 may be embodied as any signal receiving element such as an antenna, input terminal or other element.

Tuner 22 is operative to tune signals including audio and/or video signals. According to an exemplary embodiment, tuner 22 is capable of tuning audio signals on at least the following designated NWS frequencies: 162.400 MHz, 162.425 MHz, 162.450 MHz, 162.475 MHz, 162.500 MHz, 162.525 MHz and 162.550 MHz. Other frequencies may also be tuned. As previously indicated herein, such audio signals may include digitally encoded emergency alert signals.

Demodulator 23 is operative to demodulate signals provided from tuner 22. According to an exemplary embodiment, demodulator 23 demodulates audio signals to thereby generate demodulated audio signals representing audio content such as an NWS audio message, a warning alert tone and/or other audio content. Audio amplifier 24 is operative to amplify the audio signals output from demodulator 23 responsive to a control signal provided from processor 27. Speaker 25 is operative to aurally output the amplified audio signals provided from audio amplifier 24.

Decoder 26 is operative to decode signals including audio and/or video signals. According to an exemplary embodiment, decoder 26 decodes audio signals provided from demodulator 23 to thereby extract digitally encoded frequency shift keyed (FSK) signals, which represent emergency alert signals indicating an emergency event. According to this exemplary embodiment, the emergency alert signals include data comprising SAME data associated with the emergency event. SAME data comprises a digital code representing information such as the specific geographical area affected by the emergency event, the type of emergency event (e.g., tornado watch, radiological hazard warning, civil emergency, etc.), and the expiration time of the event alert. SAME data is used by the NWS and other authorities to improve the specificity of emergency alerts and to decrease the frequency of false alerts. Other data and information may also be included in the emergency alert signals according to the present invention.

Processor and memory 27 are operative to perform various processing and data storage functions of television signal receiver 20. According to an exemplary embodiment, processor 27 receives the emergency alert signals from decoder 26 and determines whether the emergency alert function of television signal receiver 20 is activated based on data included in the emergency alert signals. According to this exemplary embodiment, processor 27 compares data in the emergency alert signals to user setup data stored in memory 27 to determine whether the emergency alert function is activated. As will be described later herein, a setup process for the emergency alert function of television signal receiver 20 allows a user to select items such as an applicable geographical area(s), and type(s) of emergency events (e.g., tornado watch, radiological hazard warning, civil emergency, etc.) which activate the emergency alert function.

When the emergency alert function of television signal receiver 20 is activated, processor 27 outputs one or more control signals which enable various operations. According to an exemplary embodiment, such control signals enable one or more alert outputs (e.g., aural and/or visual) to thereby notify individuals of the emergency event. Such control signals may also enable other operations of television signal receiver 20, such as causing it to be switched from an off/standby mode to an on mode.

Processor and memory 27 are also operative to perform a distance checking function during the aforementioned setup process for the emergency alert function. According to an exemplary embodiment, memory 27 stores data associated with the emergency alert function of television signal receiver 20. Such data comprises a listing of all geographical areas associated with the emergency alert function, which may for example be represented by Federal Information Processing Standard (FIPS) location codes. Memory 27 also stores other data associated with each of the geographical areas, including for example data representing the coordinates of one or more predetermined points associated with each geographical area, such as the center or other point. Center points may for example be obtained by taking the centroids of each geographical area, which may be provided from sources such as NOAA. Memory 27 may also store transmitter data representing the locations (e.g., coordinates), transmission frequencies, and transmission ranges of all transmitters which transmit emergency alert signals. Such transmitter data may also be obtained from a source such as NOAA.

During the setup process for the emergency alert function, processor 27 receives user inputs representing geographical areas of interest, and uses the data in memory 27 to perform the distance checking function. According to an exemplary embodiment, processor 27 computes a distance between a reference point and a point associated with a geographical area selected by the user, and enables a predetermined output when the computed distance exceeds a predetermined distance. In this manner, the geographical areas selected by the user during the setup process must be sufficiently close to the reference point to ensure proper reception of emergency alert signals. Further details regarding the distance checking function of the present invention will be provided later herein.

Video processor 28 is operative to process signals including video signals. According to an exemplary embodiment, such video signals may include embedded messages such as NWS text messages and/or other messages that provide details regarding emergency events. Video processor 28 may include closed caption circuitry which enables closed caption displays. Display 29 is operative to provide visual displays corresponding to processed signals provided from video processor 28. According to an exemplary embodiment, display 29 may provide visual displays including the aforementioned messages that provide details regarding emergency events.

Turning now to FIG. 3, a flowchart 30 illustrating exemplary steps according to the present invention is shown. For purposes of example and explanation, the steps of FIG. 3 will be described with reference to television signal receiver 20 of FIG. 2. The steps of FIG. 3 are merely exemplary, and are not intended to limit the present invention in any manner.

At step 31, a setup process for the emergency alert function of television signal receiver 20 is performed. According to an exemplary embodiment, a user performs this setup process by providing inputs to television signal receiver 20 (e.g., using a remote control device not shown) responsive to an on-screen user interface displayed via display 29. Such an interface may for example be part of an electronic program guide (EPG) function of television signal receiver 20. According to an exemplary embodiment, the user may select at least the following items during the setup process at step 31:
A. Enable/Disable—The user may select whether to enable or disable the emergency alert function.
B. Frequency Selection—The user may select the monitoring frequency to tune to in order to receive emergency alert signals. For example, the user may select a frequency such as one of the following NWS transmission frequencies: 162.400 MHz, 162.425 MHz, 162.450 MHz, 162.475 MHz, 162.500 MHz, 162.525 MHz and 162.550 MHz.
C. Geographical Areas—The user may select one or more geographical areas of interest. For example, the user may select a particular continent, country, region, state, area code, zip code, city, county, municipality, subdivision, and/or other definable geographical area. According to an exemplary embodiment, such geographical area(s) may be represented by location data, such as FIPS location codes. Further details regarding item C of the setup process will be provided later herein.
D. Event Types—The user may select one or more types of emergency events which activate the emergency alert function. For example, the user may designate that events such as civil emergencies, radiological hazard warnings, and/or tornado warnings activate the emergency alert function, but that events such as a thunderstorm watch does not, etc. The user may also select whether the conventional warning audio tone provided by the NWS and/or other alert mechanism activates the emergency alert function. According to the present invention, different severity or alert levels (e.g., statement, watch, warning, etc.) may represent different “events.” For example, a thunderstorm watch may be considered a different event from a thunderstorm warning.
E. Alert Outputs—The user may select one or more types of alert outputs to be provided when the emergency alert function is activated. According to an exemplary embodiment, the user may select visual and/or aural outputs to be provided for each type of emergency event that activates the emergency alert function. For example, the user may select to display a visual message (e.g., an NWS text message as a closed caption display) and/or tune television signal receiver 20 to a specific channel. The user may also for example select to aurally output a warning tone (e.g., chime, siren, etc.) and/or an audio message (e.g., NWS audio message), and the desired volume of each. Moreover, the alert outputs may be selected on an event-by-event basis. Other types of alert outputs may also be provided according to the present invention.

According to the present invention, other user selections may also be provided at step 31 and/or some of the user selections described above may be omitted. Data corresponding to the user's selections during the setup process of step 31 is stored in memory 27.

Referring now to FIG. 4, a flowchart 31 illustrating further exemplary details regarding item C of step 31 in FIG. 3 is provided. That is, flowchart 31 provides further exemplary details of the user setup process of step 31 for selecting one or more geographical areas of interest. The steps of FIG. 4 are merely exemplary, and are not intended to limit the present invention in any manner.

At step 41, the user selects a first geographical area of interest. According to an exemplary embodiment, the user selects this geographical area by providing inputs to television signal receiver 20 (e.g., using a remote control device not shown) responsive to an on-screen user interface displayed via display 29. FIG. 5 is a diagram of television signal receiver 20 providing such a user interface 50 according to an exemplary embodiment of the present invention. As indicated in FIG. 5, the user may select the first geographical area (i.e., LOCATION 1) at step 41 via interface 50 by entering a FIPS location code (i.e., 01867) associated with the geographical area. User interface 50 is an example only, and other types of interfaces and/or other means for selecting a geographical area may also be provided according to the present invention. For example, the user may select a geographical area from a menu, rather than directly entering a FIPS location code.

At step 42, a reference point is determined responsive to the user selection at step 41. According to an exemplary embodiment, processor 27 is programmed to determine the reference point at step 42 to be the center point or some other predetermined point associated with the geographical area selected at step 41. As previously indicated herein, memory 27 may store data including the coordinates of the center point and/or other predetermined points of each geographical area. Accordingly, at step 42, processor 27 may access such data from memory 27, and designate a predetermined point such as the center point of the geographical area selected at step 41 as the reference point.

According to another exemplary embodiment, processor 27 determines the reference point at step 42 to correspond to a location of a transmitter which transmits emergency alert signals to the geographical area selected at step 41. Also previously stated herein, memory 27 may store transmitter data indicating the locations (e.g., coordinates), transmission frequencies, and transmission ranges of all transmitters which transmit emergency alert signals. Accordingly, at step 42, processor 27 may access such transmitter data from memory 27, identify a particular transmitter which is capable of providing emergency alert signals to the geographical area selected at step 41, and designate the location of that particular transmitter as the reference point. With this exemplary embodiment, the particular transmitter whose location is determined as the reference point may be a matter of design choice. For example, in order to make the determination at step 42, processor 27 may be programmed to consider factors such as the distance between the transmitter and one of more points (e.g., center point) associated with the geographical area selected at step 41, the transmission range of the transmitter, and/or other factors.

At step 43, the user may select another geographical area of interest. According to an exemplary embodiment, the user may select a geographical area at step 43 in the same manner described above at step 41, namely via an on-screen interface such as interface 50 of FIG. 5.

When the user decides to select another geographical area at step 43, process flow advances to step 44 where a distance is computed between the reference point determined at step 42 and a predetermined point associated with the geographical area selected at step 43. According to an exemplary embodiment, processor 27 is programmed to compute the distance at step 44 using data from memory 27. As previously indicated herein, the reference point determined at step 42 may for example be the center point of the geographical area selected at step 41, or may correspond to the location of a transmitter which transmits emergency alert signals to the geographical area selected at step 41. Also according to an exemplary embodiment, the predetermined point associated with the geographical area selected at step 43 may be its center point, or another predetermined point which may be a matter of design choice.

According to the present invention, distance may be computed at step 44 according to various different methods. Such methods may for example use latitude and longitude coordinates such as degrees, minutes, and seconds. One such method may be known as the Haversine Formula represented below:
dlon=lon2−lon1
dlat=lat2−lat1
a=(sin(dlat/2))A2+cos(lat1)*cos(lat2)*(sin(dlon/2))A2
c=2*arcsin(sqrt(a))
d=R*c
where there are two locations (1) and (2), where lon and lat are longitude and latitude, respectively, where R is the radius of the earth (in any units, such as miles), and where d is the distance between the points (in units of R).

Accordingly, at step 44, processor 27 computes the distance between the reference point determined at step 42 and a predetermined point (e.g., center point) associated with the geographical area selected at step 43 using data in memory 27.

At step 45, a determination is made as to whether the distance computed at step 44 exceeds a predetermined distance. According to the present invention, processor 27 is programmed to make the determination at step 45 and the predetermined distance used in this determination may be a matter of design choice. According to an exemplary embodiment, when the reference point used by processor 27 to compute the distance at step 44 is a center point or some other predetermined point associated with the geographical area selected at step 41, the predetermined distance used at step 45 may be in the range of 50 to 200 miles, or another suitable range. According to another exemplary embodiment, when the reference point used by processor 27 to compute the distance at step 44 corresponds to the location of a particular transmitter which transmits emergency alert signals to the geographical area selected at step 41, the predetermined distance used at step 45 may correspond to the transmission range of the particular transmitter.

If the determination at step 45 is positive, process flow advances to step 46 where a predetermined output message is provided. FIG. 6 is a diagram of television signal receiver 20 providing such an output message 60 according to an exemplary embodiment of the present invention. As indicated in FIG. 6, output message 60 may for example inform the user that the location of the geographical area selected at step 43 is not close enough to the location of the geographical area selected at step 41 (i.e., LOCATION 1), and prompt the user to select another geographical area. Output message 60 of FIG. 6 is an example only, and other types of output messages (e.g., visual and/or aural messages) may be provided at step 46 according to the present invention.

From step 46, process flow loops back to step 43 where the user may select another geographical area of interest to replace the previously selected geographical area which was deemed to be beyond the allowable, predetermined distance range. Steps 44 and 45 may then repeated in the manner described above.

If the determination at step 45 is negative, process flow loops back to step 43 where the user may select another geographical area of interest. If the user decides to select another geographical area at step 43, process flow advances to step 44, and the previously described steps are repeated in the manner indicated in FIG. 4. Alternatively, if the user decides not to select another geographical area at step 43, process flow advances to step 47 where the process ends.

Referring now back to FIG. 3, at step 32, television signal receiver 20 monitors the frequency selected by the user during the setup process of step 31 (i.e., item B) for emergency alert signals. According to an exemplary embodiment, tuner 22 monitors the selected frequency and thereby receives incoming emergency alert signals. According to the present invention, television signal receiver 20 is capable of monitoring a frequency and receiving emergency alert signals during all modes of operation, including for example when television signal receiver 20 is turned on, turned off, and/or during playback of recorded audio and/or video content.

At step 33, a determination is made regarding whether the emergency alert function of television signal receiver 20 is activated. According to an exemplary embodiment, processor 27 makes this determination by comparing data included in the incoming emergency alert signals to data stored in memory 27 from the setup process of step 31. As previously indicated herein, the emergency alert signals may include data such as SAME data which represents information including the specific geographical area(s) affected by the emergency event and the type of emergency event (e.g., tornado watch, radiological hazard warning, civil emergency, etc.). According to an exemplary embodiment, processor 27 compares this SAME data to the corresponding data from the setup process of step 31 (i.e., items C and D) stored in memory 27 to thereby determine whether the emergency alert function is activated. In this manner, the emergency alert function of television signal receiver 20 is activated when the emergency event indicated by the emergency alert signals corresponds to the geographical area(s) and event type(s) designated by the user at step 31.

If the determination at step 33 is negative, process flow loops back to step 32 where tuner 22 continues to monitor the selected frequency. Alternatively, if the determination at step 33 is positive, process flow advances to step 34 where television signal receiver 20 provides one or more alert outputs. According to an exemplary embodiment, processor 27 enables the one or more alert outputs at step 34 in accordance with the user's selections during the setup process of step 31 (i.e., item E), and such alert outputs may be aural and/or visual in nature. For example, aural outputs such as a warning tone and/or an NWS audio message may be provided at step 34 via speaker 25, and the volume of such aural outputs may be controlled in accordance with the volume level set by the user during the setup process of step 31. Visual outputs may also be provided at step 34 via display 29 to notify individuals of the emergency event. According to an exemplary embodiment, an auxiliary information display such as an NWS text message (e.g., as a closed caption display) and/or a video output from a specific channel may be provided at step 34 via display 29 under the control of processor 27.

According to another exemplary embodiment, the alert output(s) provided at step 34 may be based on the severity or alert level of the particular emergency event. For example, emergency events may be classified in one of three different alert level categories, such as statement, watch, and warning. With such a classification scheme, the alert output for an emergency event at a level 1 or statement level may be provided by an unobtrusive notification means such as a blinking light emitting diode (LED) since it is the least severe type of emergency event. The alert output for an emergency event at a level 2 or watch level may have some type of audio component (e.g., radio message). The alert output for an emergency event at a level 3 or warning level may be provided by a siren or other type of alarm since it is the most severe type of emergency event. Other types of aural and/or visual alert outputs than those expressly described herein may also be provided at step 34 according to the present invention.

As described herein, the present invention provides a television signal receiver having an emergency alert function capable of, among other things, checking a distance between a reference point and a point associated with a geographical area selected by a user during a setup process for the emergency alert function, and providing a predetermined output when the distance exceeds a predetermined distance.

The present invention may be applicable to various apparatuses, either with or without a display device. Accordingly, the phrase “television signal receiver” as used herein may refer to systems or apparatuses capable of receiving and processing television signals including, but not limited to, television sets, computers or monitors that include a display device, and systems or apparatuses such as set-top boxes, video cassette recorders (VCRs), digital versatile disk (DVD) players, video game boxes, personal video recorders (PVRs), computers or other apparatuses that may not include a display device.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method for controlling a television signal receiver having an emergency alert function with an associated setup process, said setup process comprising:
receiving an input representing a geographical area; and
providing a predetermined output when a distance between a reference point and a predetermined point associated with said geographical area exceeds a predetermined distance.

2. The method of claim 1, wherein said geographical area is represented by a FIPS location code.

3. The method of claim 1, wherein said reference point is a point associated with another geographical area.

4. The method of claim 3, wherein said reference point is a center point of said other geographical area.

5. The method of claim 1, wherein said reference point corresponds to a location of a transmitter which transmits emergency alert signals.

6. The method of claim 5, wherein said predetermined distance corresponds to a transmission range of said transmitter.

7. The method of claim 1, wherein said predetermined point associated with said geographical area is a center point of said geographical area.

8. A television signal receiver having an emergency alert function, comprising:
a memory operative to store data associated with said emergency alert function; and
a processor operative to receive an input representing a geographical area, and to enable a predetermined output responsive to said input using said data in said memory when a distance between a reference point and a point associated with said geographical area exceeds a predetermined distance.

9. The television signal receiver of claim 8, wherein said geographical area is represented by a FIPS location code.

10. The television signal receiver of claim 8, wherein said reference point is a point associated with another geographical area.

11. The television signal receiver of claim 10, wherein said reference point is a center point of said other geographical area.

12. The television signal receiver of claim 8, wherein said reference point corresponds to a location of a transmitter which transmits emergency alert signals.

13. The television signal receiver of claim 12, wherein said predetermined distance corresponds to a transmission range of said transmitter.

14. The television signal receiver of claim 8, wherein said predetermined point associated with said geographical area is a center point of said geographical area.

15. A television signal receiver having an emergency alert function, comprising:
memory means for storing data associated with said emergency alert function; and
processing means for receiving an input representing a geographical area, and enabling a predetermined output responsive to said input using said data in said memory means when a distance between a reference point and a point associated with said geographical area exceeds a predetermined distance.

16. The television signal receiver of claim 15, wherein said geographical area is represented by a FIPS location code.

17. The television signal receiver of claim 15, wherein said reference point is a point associated with another geographical area.

18. The television signal receiver of claim 17, wherein said reference point is a center point of said other geographical area.

19. The television signal receiver of claim 15, wherein said reference point corresponds to a location of a transmitter which transmits emergency alert signals.

20. The television signal receiver of claim 19, wherein said predetermined distance corresponds to a transmission range of said transmitter.

21. The television signal receiver of claim 15, wherein said predetermined point associated with said geographical area is a center point of said geographical area.
